(19) United States
(12) Patent Application Publication
(10) Pub. No.: US 2008/0157587 A1
(43) Pub. Date: Jul. 3, 2008

(54) Auxiliary braking system for a vehicle

(76) Inventor: Ta-Chang Huang, Taichung (TW)

Correspondence Address: Hershkovitz & Associates, LLC, 2845 Duke Street, Alexandria, VA, 22314, US

(21) Appl. No.: 11/648,609

(22) Filed: Jan. 3, 2007

(51) Int. Cl. B60T 13/66

(52) U.S. Cl. 303/20

(57) ABSTRACT

An auxiliary braking system has a main controller, a holding device, a rotating member, a pressure switch, a rotating sensor assembly and a pressed switch. The main controller has a time setting device. The holding device has a cable sleeve, a cable, a holding element and a clutch. The holding element is mounted on one end of the cable and is connected to a brake pedal of the vehicle. The clutch is connected to cable. The rotating member is mounted around a transmission axle of the vehicle. The pressure switch is electrically connected to the main controller to detect a pressure of a braking oil system of the vehicle. The rotating sensor assembly corresponds to the rotating member to detect the rotation of the rotating member. The pressed switch is electrically connected to the main controller and is contacted with an accelerator pedal of the vehicle.

### BACKGROUND OF THE INVENTION

1. Field of the Invention

The present invention relates to an auxiliary braking system, and more particularly to an auxiliary braking system for a vehicle to hold the brake pedal when the vehicle is stopped.

2. Description of Related Art

When a vehicle is stopped for traffic light, a driver always 1) shifts into the parking (P) gear, 2) lifts the hand brake or 3) steps on the brake pedal at the drive (D) gear to keep the vehicle stopping. However, if the driver keeps stepping on the brake pedal, the brake pedal is easily released due to carelessness or tiredness of the driver and accident easily occurs.

To overcome the shortcomings, the present invention tends to provide an auxiliary braking system to mitigate or obviate the aforementioned problems.

### SUMMARY OF THE INVENTION

The main objective of the invention is to provide an auxiliary braking system for a vehicle to hold the brake pedal and to keep the vehicle at a stop condition even that the driver releases the brake pedal. The auxiliary braking system comprises a main controller, a holding device, a rotating member, a pressure switch, a rotating sensor assembly and a pressed switch. The main controller has a time setting device. The holding device comprises a cable sleeve, a cable, a holding element and a clutch. The cable extends through the cable sleeve and has a first end and a second end. The holding element is mounted on the first end of the cable and is connected to a brake pedal of the vehicle. The clutch is connected to the second end of the cable and is electrically connected to the main controller. The rotating member is mounted around a transmission axle of the vehicle and comprises an annular element and multiple teeth. The annular element is mounted around and rotated with the transmission axle. The teeth are formed around the annular element. The pressure switch is electrically connected to the main controller to detect a pressure of a braking oil system of the vehicle. The rotating sensor assembly corresponds to and aligns with the rotating member to detect the rotation of the rotating member and is electrically connected to the main controller. The pressed switch is electrically connected to the main controller and is contacted with an accelerator pedal of the vehicle.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of an auxiliary braking system in accordance with the present invention;

FIG. 2 is a perspective view of the main controller of the auxiliary braking system in FIG. 1;

FIG. 3 is a side view in partial section of the holding device of the auxiliary braking system in FIG. 1 being connected with a brake pedal of a vehicle;

FIG. 4 is a side view in partial section of the rotating member and the rotating sensor assembly of the auxiliary braking system in FIG. 1;

FIG. 5 is a side view of the pressure switch of the auxiliary braking system in FIG. 1;

FIG. 6 is an operational side view of the pressure switch of the auxiliary braking system in FIG. 1 with an accelerator pedal of a vehicle; and

FIG. 7 is an operational side view in partial section of the holding device of the auxiliary braking system in FIG. 3 showing that the brake pedal is held in a braking position.

### DETAILED DESCRIPTION OF PREFERRED EMBODIMENT

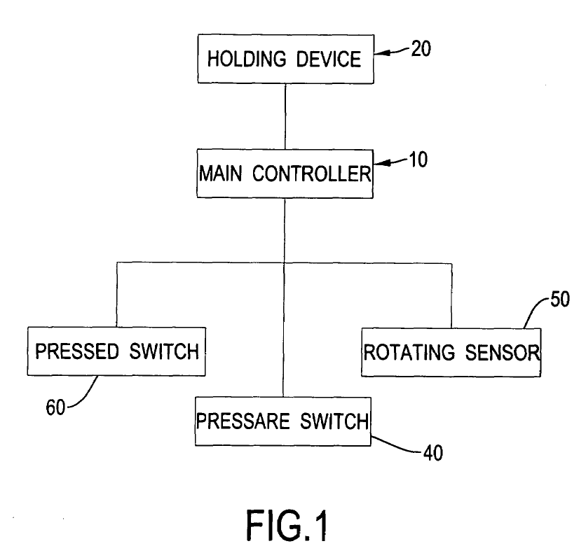

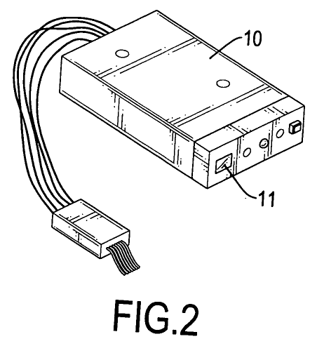

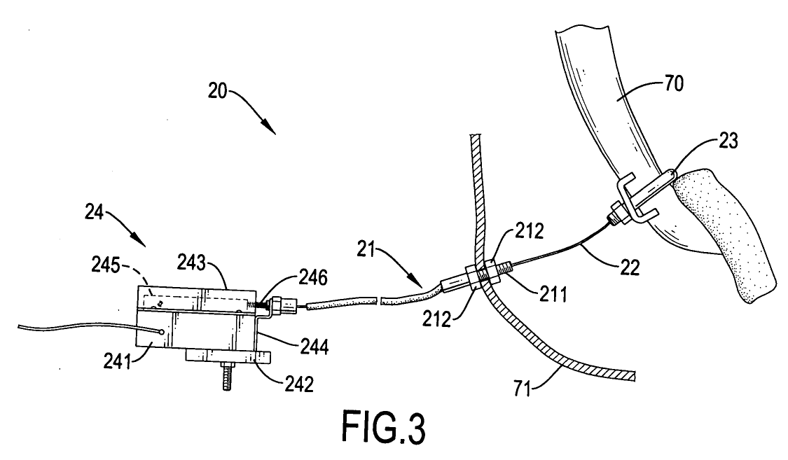

With reference to FIGS. 1 to 3, an auxiliary braking system for a vehicle comprises a main controller (10), a holding device (20), a rotating member (30), a pressure switch (40), a rotating sensor assembly (50) and a pressed switch (60).

The main controller (10) has a time setting device (11) for setting up a time period and is electrically connected to an electrical power source in the vehicle.

The holding device (20) comprises a cable sleeve (21), a cable (22), a holding element (23) and a clutch (24). The cable sleeve (21) has a first end, a second end and a threaded portion (211) formed on the first end. Two nuts (212) are screwed onto the threaded portion (211) on the cable sleeve (21) and squeeze a baffle (71) in the vehicle to hold the cable sleeve (21) onto the baffle (71).

The cable (22) extends through the cable sleeve (21) and has a first end and a second end.

The holding element (23) is mounted on the first end of the cable (22) and is adapted to be connected to a brake pedal (70) of the vehicle. In practice, the holding element (23) is a collar adapted to be mounted around the brake pedal (70) of the vehicle.

The clutch (24) is connected to the second end of the cable (22) and is electrically connected to the main controller (10). The clutch (24) comprises a holder (242), an electromagnet (241), a cap (243), a cable bracket (244), an attracted element (245) and a spring (246). The holder (242) is secured on the vehicle. The electromagnet (241) is mounted on the holder (242) and is electrically connected to the main controller (10) to be activated by the main controller (10). The cap (243) is mounted on the top of the electromagnet (241). The cable bracket (244) is mounted on one side of the electromagnet (244) and is connected to the second end of the cable sleeve (21). The second end of the cable (22) extends through the cable bracket (244) and into the cap (243).

The attracted element (245) is slidably mounted in the cap (243), corresponds to the electromagnet (241) and is connected to the second end of the cable (22). The attracted element (245) may be a metallic block or a magnet.

The spring (246) is mounted around the cable (22) and has two ends abutting respectively with the attracted element (245) and the cable bracket (244) to provide a damping effect to the attracted element (245).

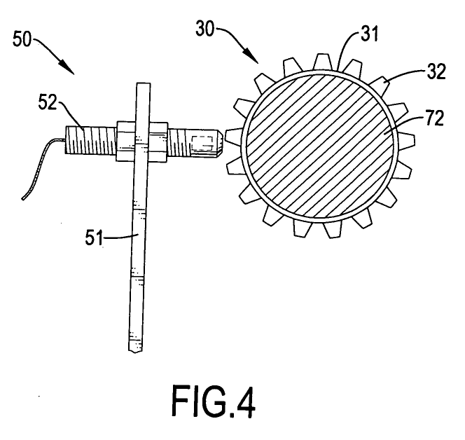

With further reference to FIG. 4, the rotating member (30) is mounted around a transmission axle (72) of the vehicle and comprises an annular element (31) and multiple teeth (32). The annular element (31) is mounted around and rotated with the transmission axle (72). The teeth (32) are formed around the annular element (31).

The rotating sensor assembly (50) corresponds to and aligns with the rotating member (30) to detect the rotation of the rotating member (30) and is electrically connected to the main controller (10). The rotating sensor assembly comprises a supporting panel (51) and a sensor (52). The supporting panel (51) is secured in the vehicle. The sensor (52) is mounted on the supporting panel (51), corresponds to and aligns with the rotating member (30) to detect the rotation of the rotating member (30) and is electrically connected to the main controller (10).

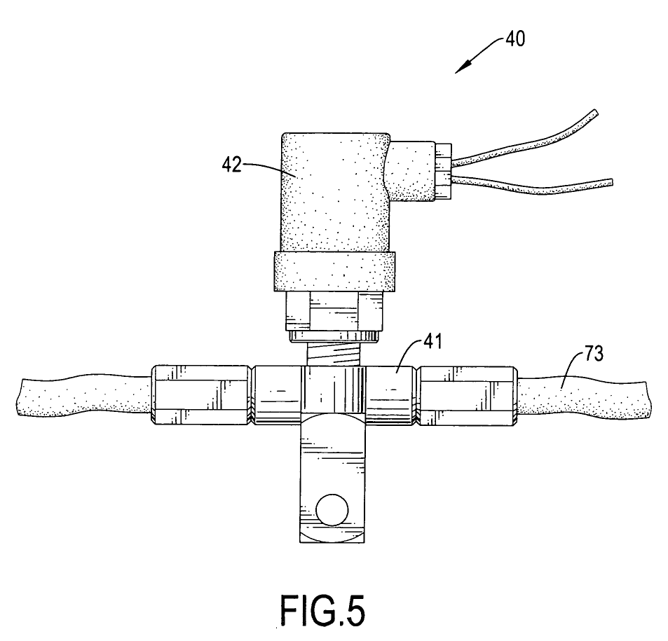

With reference to FIG. 5, the pressure switch (40) is electrically connected to the main controller (10) to detect a pressure of a braking oil system (73) of the vehicle. The pressure switch (40) comprises a control valve (41) and a pressure sensor (42). The control valve (41) is connected to the brake oil system (73) of the vehicle. The pressure sensor (42) is electrically connected to the main controller (10) and is mounted on the control valve (41) to detect the pressure in the brake oil system (73).

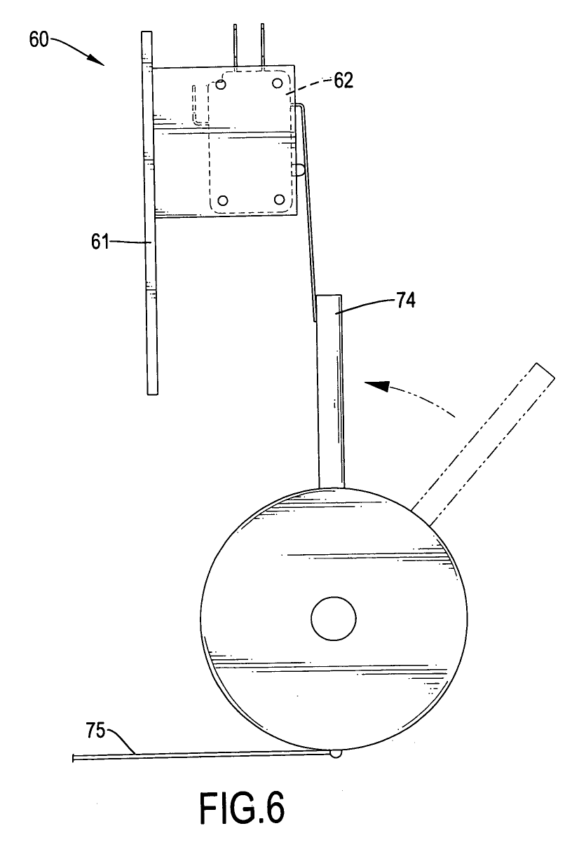

With reference to FIG. 6, the pressed switch (60) is electrically connected to the main controller (10) and is contacted with an accelerator pedal (74) of the vehicle. The pressed switch (60) comprises a supporting board (61) and a switch element (62). The supporting board (61) is secured in the vehicle. The switch element (62) is electrically connected to the main controller (10), is mounted on the supporting board (61) and is contacted with the accelerator pedal (74) of the vehicle.

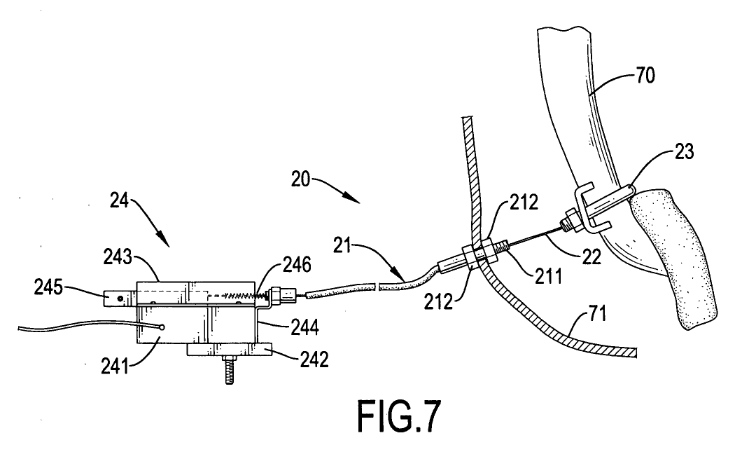

In operation, with reference to FIGS. 1 to 7, when a driver steps on the brake pedal (70), the vehicle will be stopped and the attracted element (245) is moved in the cap (243) with the transmission of the cable (22). When the vehicle is stopped, the transmission axle (72) with the rotating member (30) is also stopped. When the rotating sensor assembly (50) detects that the rotating member (30) is stopped from rotation, a signal is sent to the main controller (10) from the sensor (52). At this time, the pressure of the bake oil in the brake oil system (73) increases for actuating the brake device in the vehicle, and the pressure sensor (42) of the pressure switch (41) detects the increase of the oil pressure and sends a single to the main controller (10). Thus, the main controller gain signals from the rotating sensor assembly (50) and the pressure switch (40) and determines that the vehicle is at a stopped condition. If the stopping time of the vehicle is over the predetermined period, such as two or three seconds defined by the time setting device (11) of the main controller (10), the main controller (10) will activate the electromagnet (241) with the electrical power provided by the electrical source on the vehicle to hold the attracted element (245) in place. Accordingly, the brake pedal (70) will be held at the stepped position by the holding device (20) to keep the vehicle at the braked and stopped condition even when the driver releases the brake pedal (70). Thus, the vehicle will not be unintentionally moved, and car accidents can be prevented. Therefore, to keep stepping on the brake pedal (70) is unnecessary to the driver when the vehicle is temporarily stopped for waiting traffic light.

When the driver steps on the accelerator pedal (74) to make the vehicle moving, the switch element (62) of the pressed switch (60) is pressed by the accelerator pedal (74) and sends a signal to the main controller (10). The main controller (10) will send a signal to deactivate the electromagnet (241), and the attracted element (245) is released from the electromagnet (241). Consequently, the attracted element (245) with the cable (22) will move backward with the movement of the brake pedal (70) and the brake pedal (70) will move to an original position to release the brake system in the vehicle. The spring (246) provides a damping effect to the attracted element (245) to keep the attracted element (245) from bumping with the cap (243).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An auxiliary braking system for a vehicle comprising:
a main controller with a time setting device;
a holding device comprising
a cable sleeve;
a cable extending through the cable sleeve and having a first end and a second end;
a holding element mounted on the first end of the cable and adapted to be connected to a brake pedal of the vehicle; and
a clutch connected to the second end of the cable and electrically connected to the main controller;
a rotating member adapted to be mounted around a transmission axle of the vehicle and comprising
an annular element adapted to be mounted around and rotated with the transmission axle; and
multiple teeth formed around the annular element;
a pressure switch electrically connected to the main controller to detect a pressure of a braking oil system of the vehicle;
a rotating sensor assembly corresponding to and aligning with the rotating member to detect the rotation of the rotating member and electrically connected to the main controller; and
a pressed switch electrically connected to the main controller and adapted to be contacted with an accelerator pedal of the vehicle.

2. The auxiliary braking system as claimed in claim 1, wherein the holding element is a collar adapted to be mounted around the brake pedal of the vehicle; and
the clutch comprises
a holder;
an electromagnet mounted on the holder and electrically connected to the main controller;
a cap mounted on the electromagnet;
a cable bracket mounted on the electromagnet and connected to the cable sleeve;
an attracted element slidably mounted in the cap, corresponding to the electromagnet and connected to the second end of the cable; and
a spring mounted around the cable and having two ends abutting respectively with the attracted element and the cable bracket.

3. The auxiliary braking system as claimed in claim 2, wherein the pressure switch comprises
a control valve adapted to be connected to the brake oil system of the vehicle; and
a pressure sensor electrically connected to the main controller and mounted on the control valve to detect the pressure in the brake oil system.

4. The auxiliary braking system as claimed in claim 3, wherein the rotating sensor assembly comprises
a supporting panel;
a sensor mounted on the supporting panel and corresponding to and aligning with the rotating member to detect the rotation of the rotating member.

5. The auxiliary braking system as claimed in claim 4, wherein the pressed switch comprises
a supporting board;
a switch element electrically connected to the main controller, mounted on the supporting board and adapted to be contacted with the accelerator pedal of the vehicle.

6. The auxiliary braking system as claimed in claim 1, wherein the pressure switch comprises
a control valve adapted to be connected to the brake oil system of the vehicle; and
a pressure sensor electrically connected to the main controller and mounted on the control valve to detect the pressure in the brake oil system.

7. The auxiliary braking system as claimed in claim 1, wherein the rotating sensor assembly comprises
a supporting panel;
a sensor mounted on the supporting panel and corresponding to and aligning with the rotating member to detect the rotation of the rotating member.

8. The auxiliary braking system as claimed in claim 1, wherein the pressed switch comprises
a supporting board;
a switch element electrically connected to the main controller, mounted on the supporting board and adapted to be contacted with the accelerator pedal of the vehicle.
